(19) United States
(12) Patent Application Publication
(10) Pub. No.: US 2013/0152353 A1
(43) Pub. Date: Jun. 20, 2013

(54) Structure of the Driving Axis of a Puller

(71) Applicant: Chih-Kuo Hu, Taichung City (TW)

(72) Inventor: Chih-Kuo Hu, Taichung City (TW)

(21) Appl. No.: 13/326,046

(22) Filed: Dec. 14, 2011

(51) Int. Cl. B23P 19/04; B25B 27/02

(52) U.S. Cl. 29/261; 29/256

(57) ABSTRACT

An improved structure of the driving axis of a puller includes a screw bar, a driving assembly with a through hole, and a driven assembly underneath the driving assembly, with a screw hole. A plurality of connecting arms is disposed in the radial direction of the driven assembly. The screw bar penetrates downward through the driving assembly and the driven assembly with its bottom end, while its top end is provided with a rotating element for mounting a tool to rotate the screw bar. With a positioning element penetrated the rotating element into the screw bar, the rotating element is fixed on the screw bar for simultaneous rotation.

### BACKGROUND OF THE INVENTION

1. Field of Invention

The invention relates to the driving axis of a puller and, in particular, to an improved structure of the driving axis of a puller to prevent the driving axis from causing safety problems due to damage.

2. Related Art

As shown in FIG. 13, a conventional puller includes a driving axis 7, a driving assembly 8, and several claws 9. The top end of the driving axis 7 is formed with a rotating part 71 for the user to mount a tool and rotate the driving axis 7. The driving assembly 8 is screwed onto the driving axis 7 and extended sideways with several connecting arms 81. The end of each of the connecting arms 81 is pivotally installed with a claw 9. Each of the claws 9 changes its opening angle as one adjusts the driving assembly 8 to hold an object (not shown). When one uses the conventional puller, the claws 9 are made to hold an object. The bottom end of the driving axis 7 urges against the axle part of a machine in which the object is embedded. The user then mounts a tool on the rotating part 71 and rotates the driving axis 7. The steady forwarding action of the driving axis 7 renders the claws 9 to pull the object out of the axle part of the machine.

However, when the object is engages in the axle part of the machine too tightly, it is usually difficult to rotate the rotating part 71 of the driving axis 7. The user may naturally exert an even larger force in hope of rotating the driving axis 7. If the torque imposed by the user on the driving axis 7 is greater than that sustainable by the driving axis 7, the stress at the junction between the driving axis 7 and the rotating part 71 becomes so large that they break up. What is even worse is that the sudden breakdown of the driving axis 7 may call for a replacement of the entire puller, as it is the primary component thereof. The maintenance is thus higher. Moreover, if the breaking happens during the tightening process of turning the rotating part 71 of the driving axis 7, the user may lose his/her center of gravity and hit the surrounding machines next to the puller, resulting in serious injuries.

### SUMMARY OF THE INVENTION

An objective of the invention is to provide an improved structure of the driving axis of a puller. With a rotating element to rotate a screw bar and a positioning element to fix the rotating element on the screw bar, only the positioning element will be damaged when the screw bar receives a large torque. This achieves the effect of reducing the maintenance cost.

To achieve the above-mentioned objective, the disclosed improved structure of the driving axis of a puller includes a screw bar, a driving assembly, and a driven assembly. The screw bar has a top end and a bottom end. The driving assembly has a through hole. The driven assembly has a screw hole and is provided with several connecting arms along the radial direction. The driven assembly is underneath the driving assembly. The bottom end of the screw bar goes through the through hole of the driving assembly and the screw hole of the driven assembly.

The invention is further characterized in that the top end of the screw bar has a rotating element for a tool to mount thereon for rotating the screw bar, that the rotating element has a corresponding space to mount on the top end, that one end of the rotating element is formed with a connecting hole connecting to the space, that the screw bar has a positioning hole corresponding to the connecting hole with a positioning element going through the connecting hole and being positioned in the positioning hole, thereby fixing the rotating element on the screw bar to rotate with the screw bar concurrently.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a three-dimensional assembly view of the first embodiment of the invention;

FIG. 2 is a three-dimensional exploded view of the first embodiment;

FIG. 3 is a locally expanded cross-sectional view of the first embodiment;

FIGS. 4, 5, and 6 are schematic action views of the first embodiment;

FIG. 7 is a three-dimensional assembly view of the second embodiment of the invention;

FIG. 8 is a top view of the second embodiment in its first usage state;

FIG. 9 is a top view of the second embodiment in its second usage state;

FIG. 10 is a top view of the second embodiment in its second usage state;

FIG. 11 is a three-dimensional assembly view of the third embodiment of the invention;

FIG. 12 is a schematic view of the third embodiment in use; and

FIG. 13 is a planar view of a conventional puller.

### DETAILED DESCRIPTION OF THE INVENTION

The present invention will be apparent from the following detailed description, which proceeds with reference to the accompanying drawings, wherein the same references relate to the same elements.

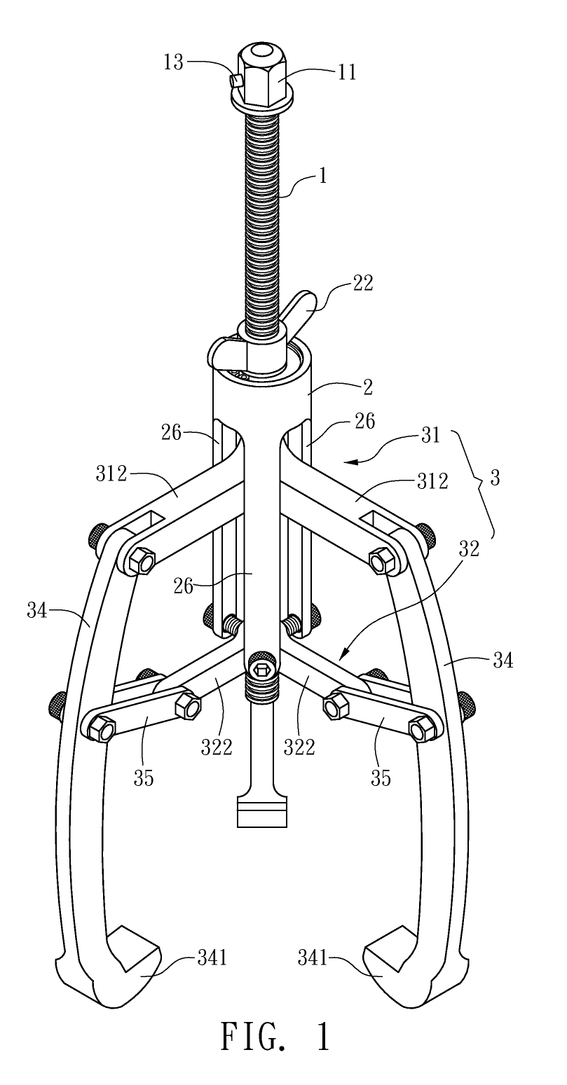

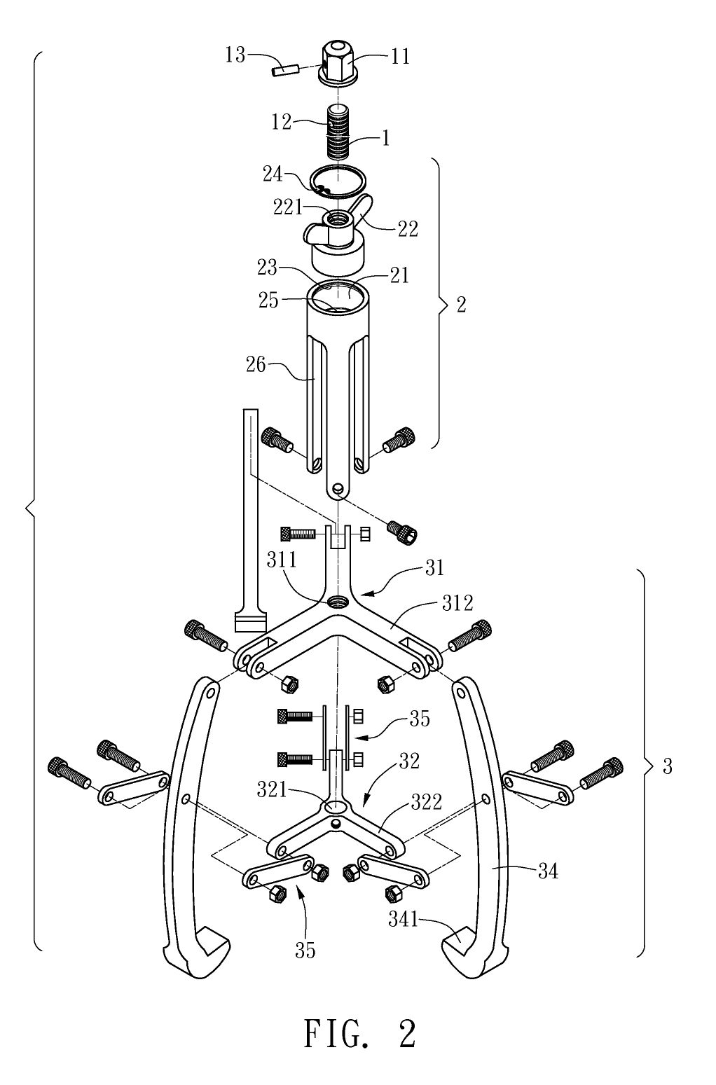

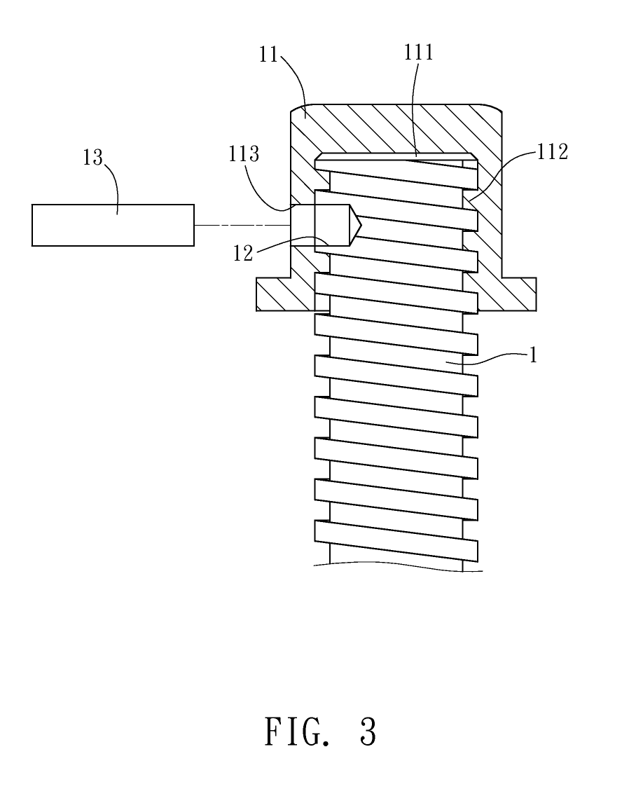

Please refer to FIGS. 1 to 3 for a first embodiment of the improved structure of the driving axis of a puller. The structure includes a screw bar 1, a driving assembly 2, and a driven assembly 3. The screw bar 1 has a top end and a bottom end. As shown in FIGS. 2 and 3, the top end of the screw bar 1 has a rotating element to mount a tool for rotating the screw bar 1. The rotating element 11 has a space 111 corresponding to the top end of the screw bar 1. The side of the space 111 has an inner thread section 112 corresponding to the top end of the screw bar 1, so that the screw bar 1 can be screwed into the space 111. One side of the rotating element 111 has a connecting hole 113 connecting to the space 111. The screw bar 1 has a positioning hole 12 corresponding to the connecting hole 113. A positioning element 13 goes through the connecting hole 113 and gets positioned inside the positioning hole 12. In this embodiment, the positioning element 13 is a pin to fix the rotating element 111 on the top end of the screw bar 1 and to rotate with the screw bar 1.

The improved screw bar is combined with the driving assembly and the driven assembly to form a puller. The driving assembly 2 has an accommodating recess 21 for the pivotal connection of a special-shaped nut 22. The top edge of the accommodating recess 21 has an annular groove 23 for embedding a C-shaped buckle, thereby positioning the special-shaped nut 22 in the accommodating recess 21. The driving assembly 2 is formed with a through hole 25. The special-shaped nut 22 has a screw hole 221. The screw bar 1 is screwed through the screw hole 221 of the special-shaped nut 22 and through the through hole 25 of the driving assembly 2. The driving assembly 2 is extended downward with several extension arms 26.

The driven assembly 3 is provided underneath the driving assembly 2. It includes a screw base 31 and a connecting base 32. The connecting base 32 is under the screw base 31. The center of the screw base 31 has a screw hole 311. The center of the connecting base 32 has a connecting hole 321. The screw bar 1 penetrates in sequence through the screw hole 311 of the screw base 31 and the connecting hole 321 of the connecting base 32. The outer part of the screw base 31 is extended outward with several fixing arms 312. The outer part of the connecting base 32 is extended outward with several connecting arms 322. The fixing arms 312 on the screw base 31 and the fixing arms 312 of the screw base 31 alternate in space. The end of each of the extension arms 26 is fixed to the connecting base 32. In this embodiment, each of the extension arms is screw-locked onto the connecting base 32. Moreover, the length of each of the fixing arms 321 of the screw base 31 is greater than that of each of the connecting arms 322 of the connecting base 32. The outer edge of each of the fixing arms 312 of the screw base 31 is pivotally connected with a claw 34. The middle section of each of the claws 34 is pivotally connected with an action arm 35. In this embodiment, the action arm 35 consists of two pieces and pivotally connects to the corresponding connecting arm 322 of the connecting base 32. The end of each of the claws 34 far from the corresponding fixing arm 312 has a hook part 341.

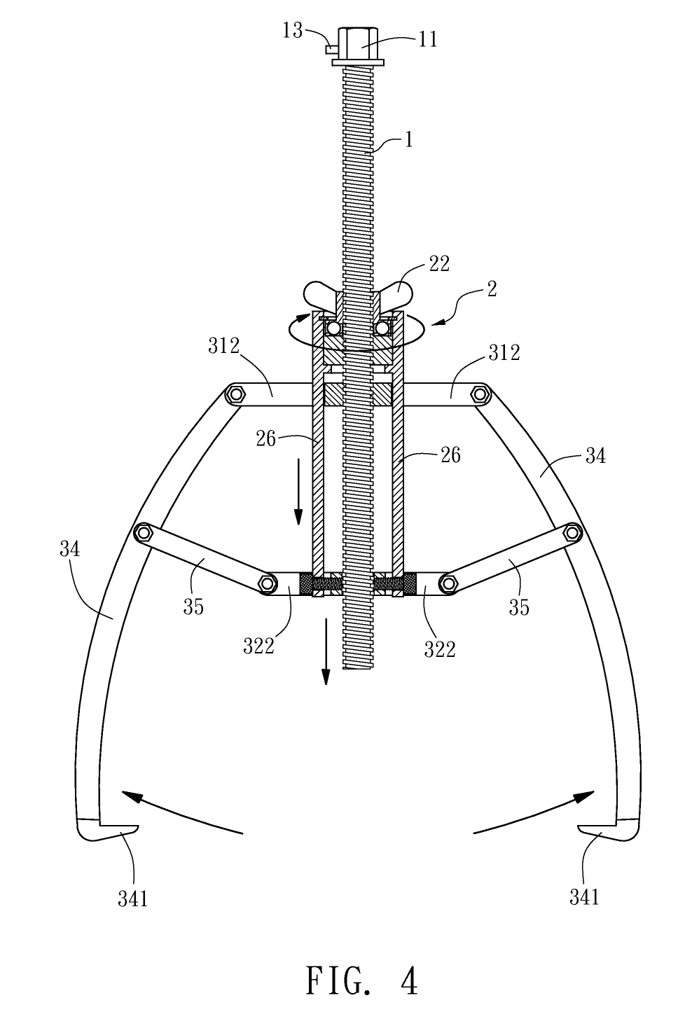

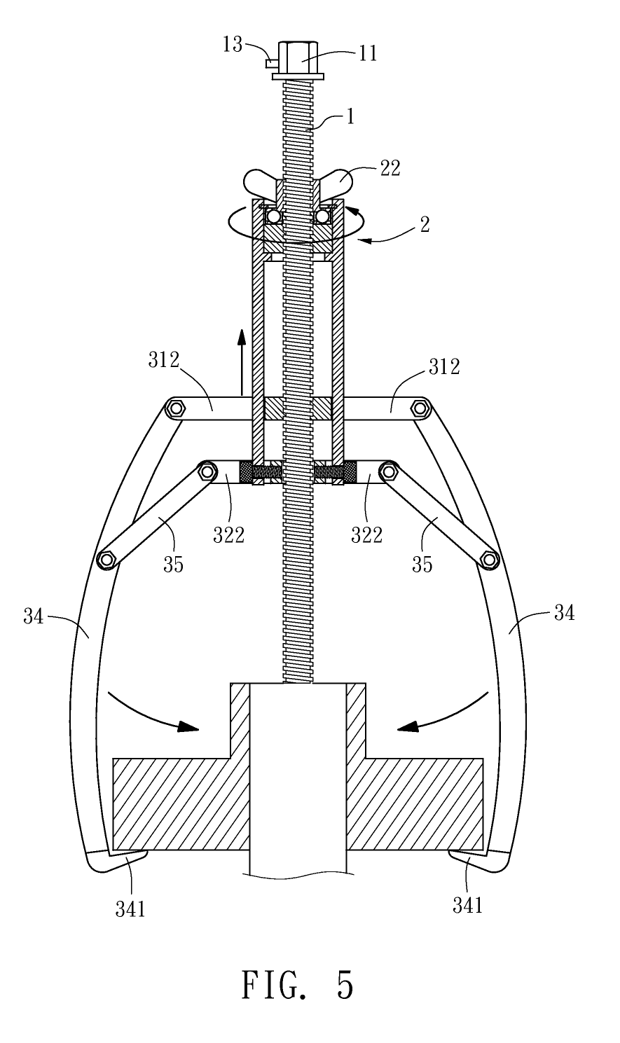

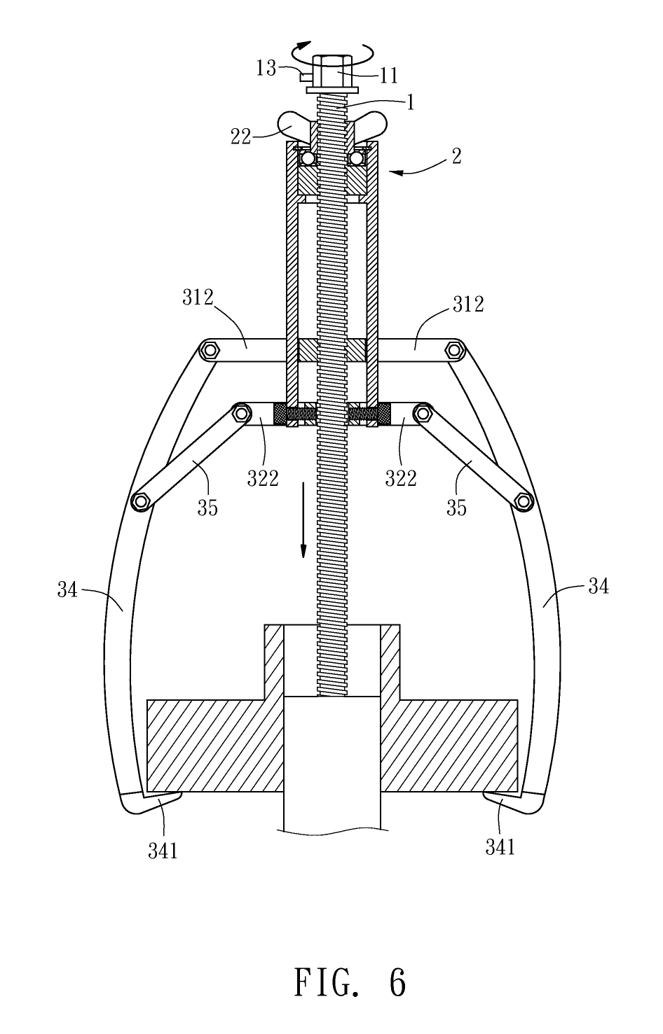

When the invention is in use, as shown in FIGS. 4 to 6, one first rotate the special-shaped nut 22. Through the connection between the special-shaped nut 22 and the screw bar 1 and with the engagement of the C-shaped buckle 24 in the annular groove 23, the driving assembly 2 makes vertical displacements, driving the connecting base 32 and the action arms 35 to adjust the claws 34 to a suitable opening width. Afterwards, one adjusts the screw bar 1 to align with the central axis of an object. The user further rotates the special-shaped nut 22 to close the claws 34 to a suitable width to pull the object. After pulling the object, a tool is mounted on the rotating element 11 on the top end of the screw bar 1. The user than exerts a force to rotate the rotating element 11. The screw bar 1 thus rotates and moves downward to urge against the object. The object is thus departed from an axle part where it is stuck.

However, suppose the object is so firmly stuck in the axle part that it is difficult to urge the axle part with a force. If one exerts a force that is not sustainable by the positioning element 13 to rotate the rotating element 11, the positioning element 13 will break. The rotation of the rotating element 11 and the screw bar 1 stops. In comparison with the conventional puller, the maintenance cost of the positioning element 13 is lower. The invention thus has better replaceability. When the exerted force is too large, the positioning element 13 breaks to protect the screw bar 1 from damages. The invention can thus reduce its cost.

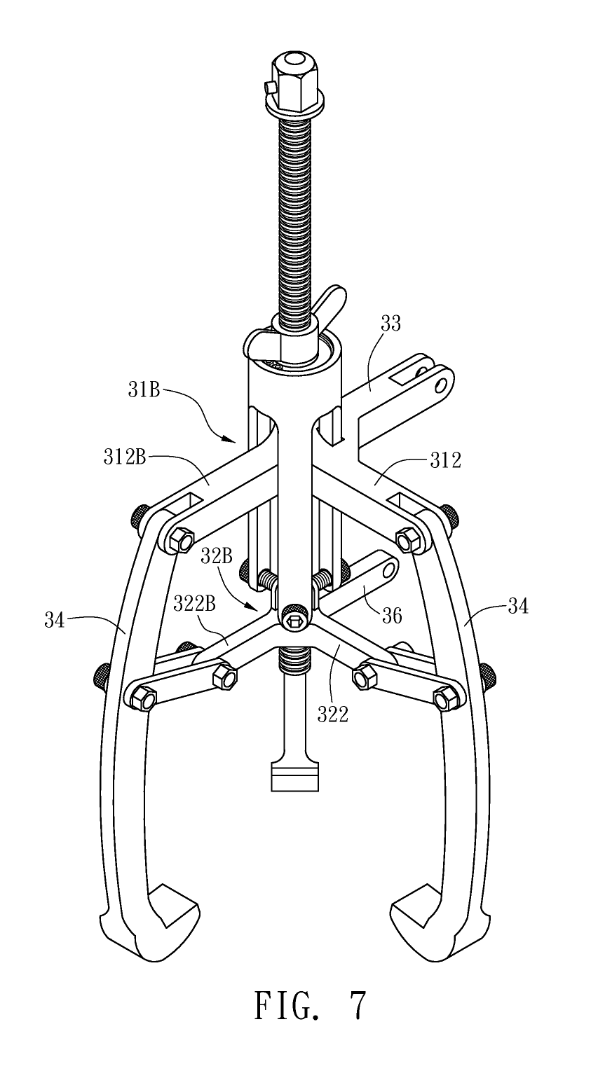

FIG. 7 shows a second embodiment of the improved structure of the driving axis of a puller. It differs from the previous embodiment in that the opposite direction of one fixing arm 312B of the screw base 31B is extended with an auxiliary fixing arm 33. The opposite direction of one connecting arm 322B of the connecting base 32B is extended with an auxiliary connecting arm 36. The auxiliary fixing arm 33 and the auxiliary connecting arm 36 and the corresponding fixing arm 312 and connecting arm 322B form a line, respectively. The rest claws 34 can be uncounted from the fixing arms 312 and the action arms 35 and connected with the auxiliary fixing arm 33 and the auxiliary connecting arm 36.

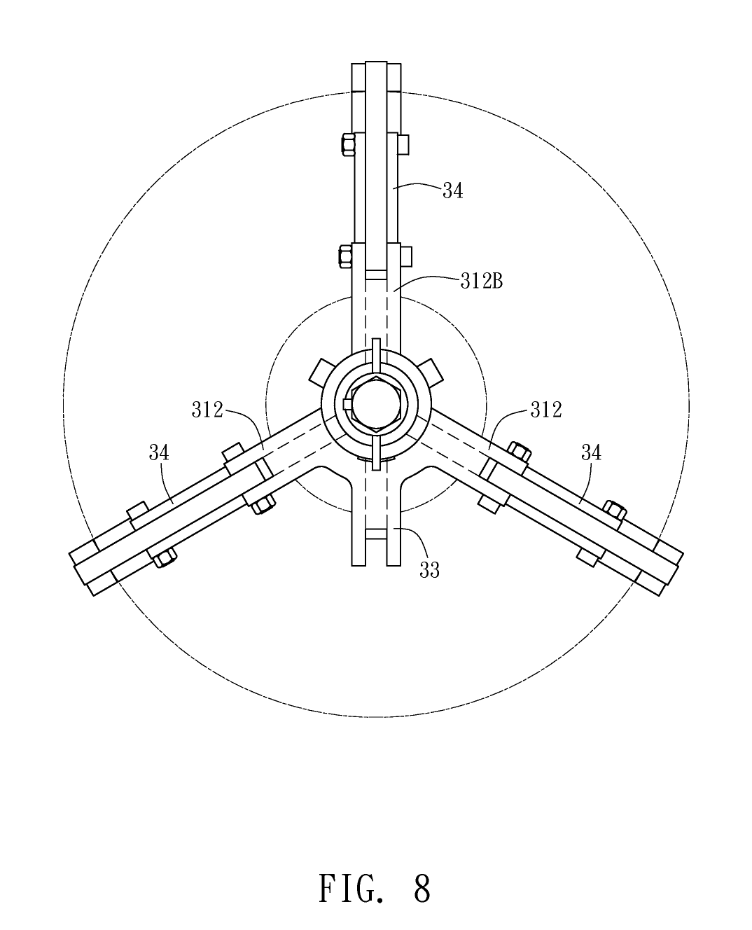

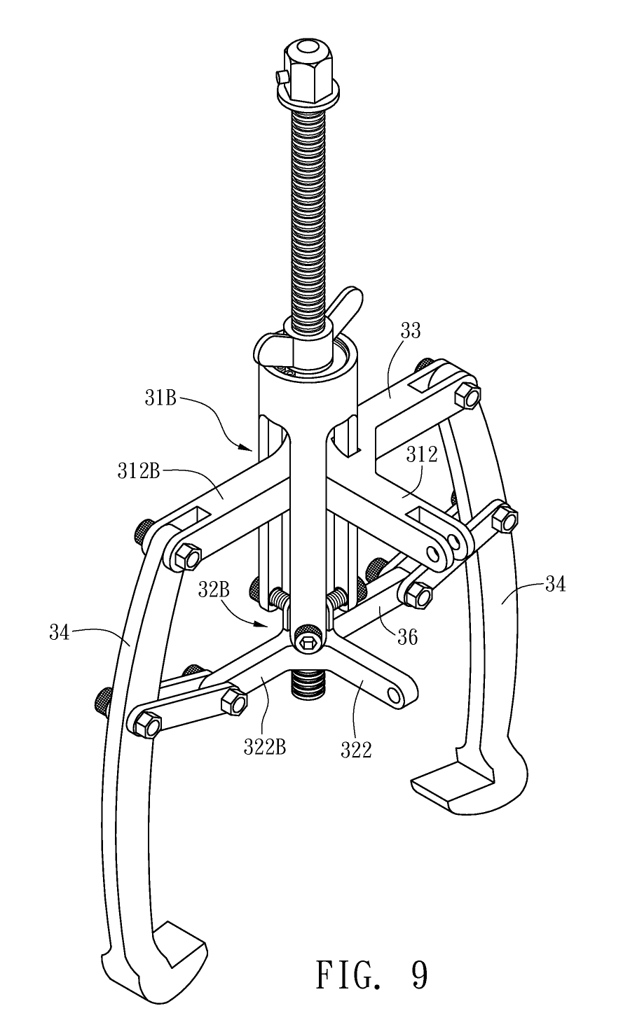

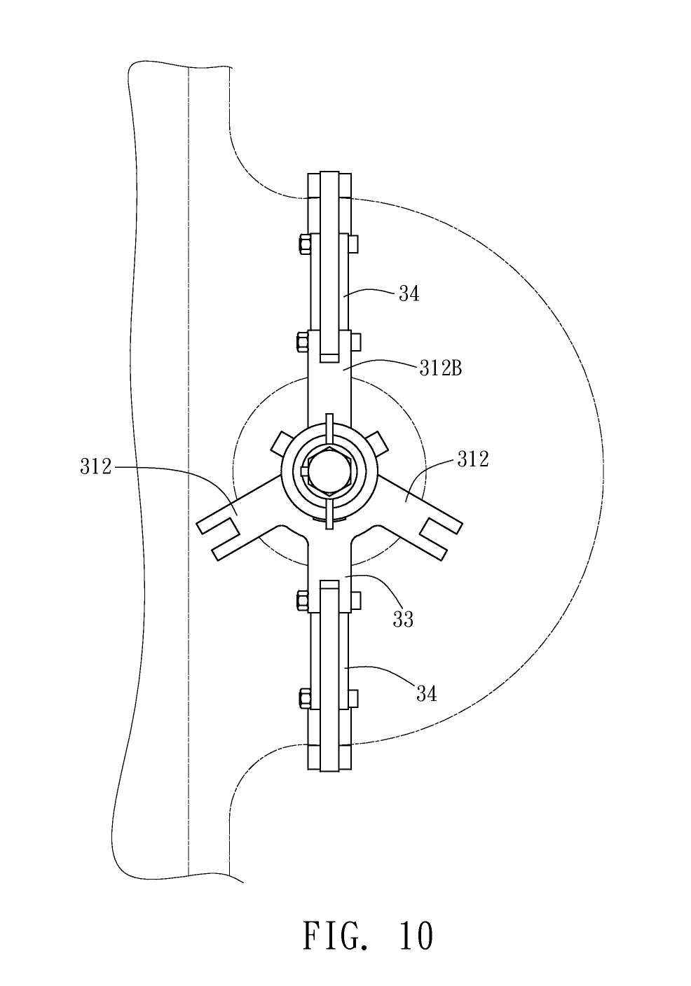

When this embodiment is in use, the claws 34 can be adopted to fit various environments. When the claws 34 are installed as shown in FIG. 7, it is the same as the first embodiment. In the case of FIG. 8, the three claws can concurrently pull an object, suitable for a more spacious environment. In a narrower space that is not sufficient for a puller with three claws, as shown in FIG. 9, two of the claws 34 can be dismounted. Instead, one claw 34 is installed on the auxiliary fixing arm 33 and the auxiliary connecting arm 36 symmetric with respect to the fixing arm 312B and the connecting arm 322B. As show in FIG. 10, it is possible to pull the object with two symmetric claws 34 in a narrow environment.

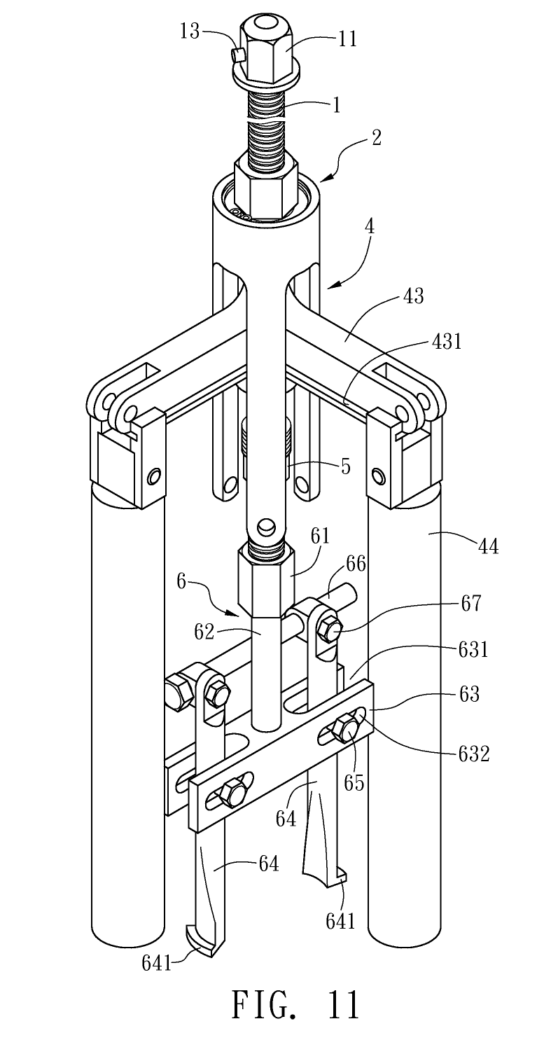

FIG. 11 shows a third embodiment of the invention. This embodiment differs from the first embodiment in that the driven assembly is a connecting base 4. The center of the connecting base 4 has a through hole 41 for the screw bar 1 to penetrate through. The bottom edge of the through hole 41 of the connecting base 4 is extended downward with a screw hole 42 whose inner diameter is greater than that of the through hole 41. The outer part of the connecting base 4 is extended outward with several connecting arms 43. Each of the connecting arms 43 has a guiding part 431 for a pushing bar 44 to be installed thereon in a slideable way.

The screw bar 1 is provided with an adjusting element 5 for adjusting and positioning the connecting base 4 under the connecting base 4. The outer edge of one end of the adjusting element 5 has an outer thread section 51 for correspondingly connecting to the screw hole 42 of the connecting base 4. The other end is a rotation section 52 for adjustment and rotation. The adjusting element 5 further has a screw hole 53 that rotates and slides along the screw bar 1. Therefore, the outer thread section 51 of the adjusting element 5 can be fixed in or departed from the screw hole 42 of the connecting base 4.

The bottom end of the screw bar 1 is pivotally connected with a pulling assembly 6 via a connecting element 61. The other end of the connecting element 61 is connected with a pushing bar 62, which in turn is connected with a positioning bar 63 for positioning. Both ends of the positioning bar 63 have a deep cut 631, respectively. Both sides of each of the deep cuts 631 are provided with a sliding hole 632. Each of the deep cuts 631 has a pulling bar 64 protruded outward with a hook part 641. A positioning element 65 goes through each of the sliding hole 632 to limit and position the corresponding pulling bar 64 within the corresponding deep cut 631. Each of the pulling bars 64 can slide along the corresponding deep cut 631.

The end of each of the pulling bar 64 far from the corresponding hook part 641 is connected with an adjusting bar 66 for adjusting the relative distance of the hook parts 641 of the pulling bars 64. Both ends of the adjusting bar are connected with an adjusting element 67 respectively to link with the corresponding pulling bar 64, so that the pulling bars 64 are fixed on the adjusting bar 66.

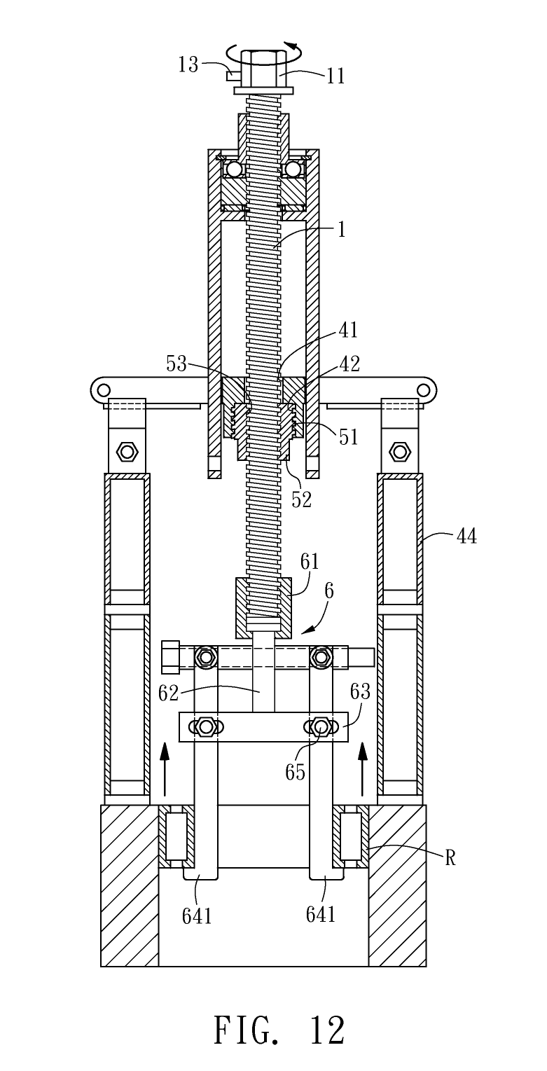

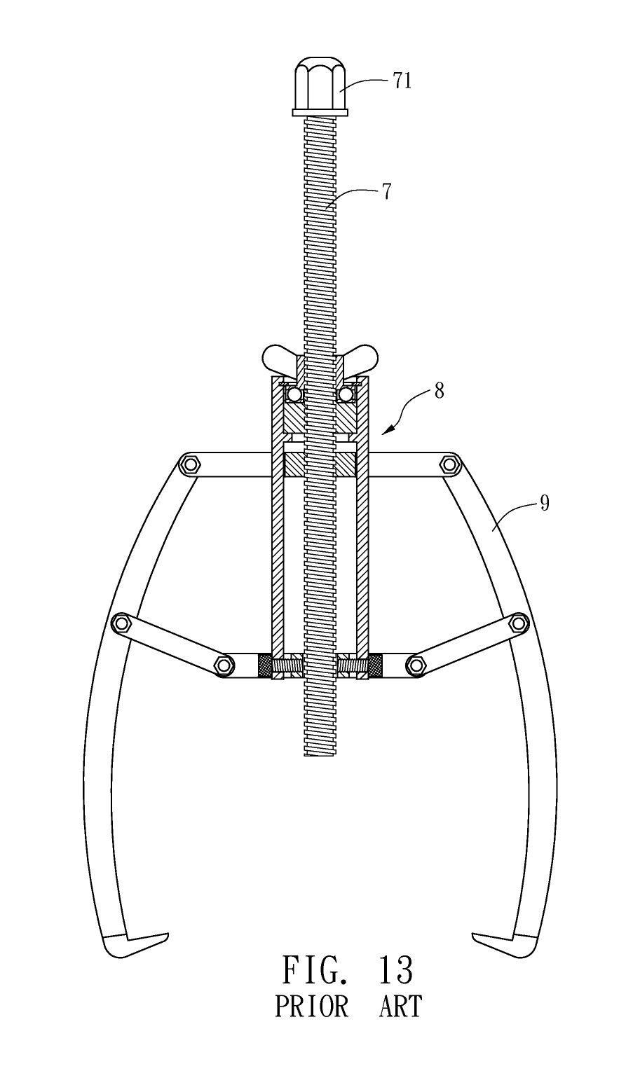

FIG. 12 is a cross-sectional view of using the invention to take off a bearing in an axle element. To use the invention, one first urges the pushing bar 44 against the axle element with the bearing R to be removed. One then uses the adjusting elements 67 to adjust the pulling bars 64 to an appropriate position, so that the hook parts 641 of the pulling bars 64 hook onto the inner edge of the bearing R. Afterwards, the user rotates the positioning elements 65 to fix the pulling bars 64.

Afterwards, the user first rotates the adjusting element 5 under the connecting base 4 upwards. The adjusting element 5 is locked via the outer thread section 51 inside the screw hole 42 at the bottom of the connecting base 4, so that the connecting base 4 foes not slide downward. The user then turn the rotating element 11 to drive the screw bar 1, making the connecting base 4 to urge against the axle element downward. At the same time, the pulling assembly 6 and the screw bar 1 displace upwards. This then achieves the goal of departing the bearing R from the axle element.

Although the invention has been described with reference to specific embodiments, this description is not meant to be construed in a limiting sense. Various modifications of the disclosed embodiments, as well as alternative embodiments, will be apparent to people skilled in the art. Therefore, it is contemplated that the appended claims will cover all modifications that fall within the true scope of the invention.

What is claimed is:

1. An improved structure of the driving axis of a puller, comprising a screw bar, a driving assembly, and a driven assembly; wherein the screw bar has a top end and a bottom end, the driving assembly has a through hole, the driven assembly has a screw hole, the driven assembly is disposed underneath the driving assembly, the bottom end of the screw bar penetrates downward through the through hole of the driving assembly and the screw hole of the driven assembly, and the improved structure is further characterized in that: the top end of the screw bar has a rotating element for mounting a tool to rotate the screw bar; the rotating element has a space corresponding to the top end of the screw bar; one side of the rotating element is formed with a connecting hole connecting to the space; the screw bar has a positioning hole corresponding to the connecting hole; and a positioning element goes through the connecting hole and gets positioned in the positioning hole, thereby fixing the rotating element on the screw bar to rotate concurrently with the screw bar.

2. The improved structure of the driving axis of a puller according to claim 1, wherein the side of the space of the rotating element is formed with an inner thread section corresponding to the top end of the screw bar.

3. The improved structure of the driving axis of a puller according to claim 1, wherein the positioning element is a pin.

4. The improved structure of the driving axis of a puller according to claim 1, wherein the driving assembly has an accommodating recess for the pivotal connection of a special-shaped nut with a screw hole; the screw bar screws in the screws hole of the special-shaped nut and penetrates through the through hole of the driving assembly; the driving assembly is extended with a plurality of extension arms away from the special-shaped nut; the driven assembly includes a screw base and a connecting base under the screw base; the center of the screw base has a screw hole; the center of the connecting base has a connecting hole; the screw bar goes through the screw hole of the screw base and the connecting hole of the connecting base; the screw base has a plurality of fixing arms away from the center thereof; the connecting base has a plurality of connecting arms away from the center thereof; the fixing arms of the screw base and the extension arms of the driving assembly alternate in space; each of the extension arms connects to the connecting base; the length of each of the fixing arms of the screw base is greater than that of each of the connecting arms; the outer edge of each of the fixing arms of the screw base is pivotally connected with a claw; the middle section of each of the claws is pivotally connected with an action arm; and each of the action arms and the corresponding connecting arms are pivotally connected.

5. The improved structure of the driving axis of a puller according to claim 4, wherein the upper edge of the accommodating recess has an annular groove where a C-shaped buckle is embedded.

6. The improved structure of the driving axis of a puller according to claim 4, wherein each of the action arms consists of two pieces.

7. The improved structure of the driving axis of a puller according to claim 4, wherein each of the claws has a hook part on the end away from the corresponding fixing arm.

8. The improved structure of the driving axis of a puller according to claim 4, wherein one of the fixing arms of the screw base is associated with an auxiliary fixing arm on the opposite direction; one of the connecting arms of the connecting base is associated with an auxiliary connecting arm on the opposite direction; the other claws are dismounted from the fixing arms and the action arms to connect with the auxiliary fixing arm and the auxiliary connecting arm.

9. The improved structure of the driving axis of a puller according to claim 8, wherein the upper edge of the accommodating recess has an annular groove where a C-shaped buckle is embedded.

10. The improved structure of the driving axis of a puller according to claim 8, wherein the action arm consists of two pieces.

11. The improved structure of the driving axis of a puller according to claim 8, wherein each of the claws has a hook part on the end away from the corresponding fixing arm.

12. The improved structure of the driving axis of a puller according to claim 1, wherein the center of the driven assembly is formed with a through hole; the screw hole is formed at the bottom edge of the through hole, with the outer diameter of the screw hole greater than that of the screw bar; the driven assembly has a plurality of connecting arms away from the screw bar; each of the connecting arms has a guiding part for a pushing bar to slide; the screw bar has an adjusting element under the driven assembly for adjusting and positioning the driven assembly; the outer edge on one end of the adjusting element has an outer thread section for correspondingly connecting to the screw hole of the driven assembly; the other end thereof is a rotating section for rotation adjustment; the adjusting element has a screw hole that rotates and slides along the screw bar for fixing onto or departing from the screw hole of the driven assembly; the bottom end of the screw bar is further provided with a pulling assembly comprising a connecting element connected to the screw bar; a pushing bar is provided inside the connecting element; the pushing bar is connected with a positioning bar for positioning; both ends of the positioning bar are connected with a pulling bar that has a protruding hook part outward, respectively; and the end of each of the pulling bars away from the corresponding hook part is connected with an adjusting bar for adjusting the relative distance of the hook part of each of the pulling bars.

13. The improved structure of the driving axis of a puller according to claim 12, wherein both ends of the positioning bar have respectively a deep cut; both side of each of the deep cuts are formed with a sliding groove, respectively; each of the deep cuts accommodates the corresponding pulling bar; and a positioning element goes through each of the sliding groove to limit and position the corresponding pulling bar in the corresponding deep cut.

14. The improved structure of the driving axis of a puller according to claim 12, wherein both ends of the adjusting bar are respectively provided with an adjusting element for the connection of the pulling bars.
